(19) United States
(12) Patent Application Publication
(10) Pub. No.: US 2004/0107143 A1
(43) Pub. Date: Jun. 3, 2004

(54) Method for authorizing indirect content download

(76) Inventor: Aki Niemi, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/306,161

(22) Filed: Nov. 29, 2002

(51) Int. Cl. G06F 17/60

(52) U.S. Cl. 705/26

(57) ABSTRACT

The invention is based on the idea to allow a User Agent (UA) to download content from its associated proxy without being charged for the necessary radio interface time. i.e. the costs for downloading the content must be deducted from the users access charge.

According to the invention, a method for authorising content download in a network system is provided. Said method comprises the steps of receiving a message with an uniform resource identifier (URI) associated to a resource on a storage server (100); requesting said resource based on said uniform resource identifier URI from said storage server (100) via a resource proxy server (110), forwarding the content associated to said resource to said resource proxy server (110); authorising a download of said forwarded content from said resource proxy server (110) to a second User Agent (UA2), performing an authorised download of said content; and subtracting the costs related to said authorised download of said content from overall costs.

The object of the invention is also solved by a network system, comprising a storage server (100) for storing a resource at a specific Uniform Resource Identifier (URI), at least a first and a second User Agent (UA1), (UA2) for transmitting and receiving messages (IM) between each other, wherein said message (IM) comprises an Uniform Resource Identifier (URI) associated to a resource stored on said storage server (100). Said network system further comprises a proxy server (110) for requesting a resource on said storage server (100) based on said Uniform Resource Identifier (URI), for receiving the content associated to said resource from said storage server (100), for authorising a download of said received content, and for performing an authorised download of said content to said second User Agents (UA2). Finally, the costs related to said authorised download of said content are subtracted from the overall costs.

### FIELD OF THE INVENTION

The invention relates to a method for authorising content download as well as a respective network system.

### BACKGROUND OF THE INVENTION

Today's wireless landscape is rapidly changing as mobile phones and networks are being enhanced to provide services beyond just voice services. A rapid expansion of mobile data services can be observed and it is being fuelled by a variety of factors, like internet and wireless domains are converging, tremendous adoption rates of SMS and its lucrative business model, mobile consumers and professionals request for new wireless applications and operators need to leverage their investment in 3G spectrums.

One of the most promising services is the Instant Messaging and Presence Service (IMPS), which usually includes four primary features namely Presence, Instant Messaging (IM), Groups, and Shared Content. Presence includes client device availability (my phone is on/off, in a call), user status (available, unavailable, in a meeting), location, client device capabilities (voice, text, GPRS, multimedia) and searchable personal statuses such as mood (happy, angry) and hobbies (football, fishing, computing, dancing). Instant Messaging (IM) is a familiar concept in both the mobile and desktop worlds. Desktop IM clients, two-way SMS and two-way paging are all forms of IM. Groups or chat are a fun and familiar concept on the internet and enables both operators and end-users to create and manage groups. Users can invite their friends and family to chat in group discussions.

The concept of Shared Content allows users and operators to set up their own storage area where they can post pictures, music and other multimedia content while enabling the sharing with other individuals and groups in an IM or chat session. During an instant messaging session, a useful service is document sharing wherein one party sends an IM with an indirect pointer to a document which is meant to be rendered by the remote party. Carrying such a document directly in the IM is not appropriate for most documents. Furthermore, the document to be shared may reside on a completely independent server from the originating party.

3GPP has selected SIP RFC 3261 (Rosenberg, J et al. “SIP: Session Initiation Protocol”, RFC 3261, June 2002.1) as the protocol to establish and tear down multimedia sessions in the IP Multimedia Core Network Subsystem (IM CN Subsystem). A description of the IM CN Subsystem can be found in 3GPP TS 23.228 (3GPP TS 23.228, “IP Multimedia (IM) Subsystem (Stage 2)—Release 5”, Version 54.1, April 2002. Version 5.5.0 is available at ftp://ftp.3gpp.org/Specs/2002-06/Rel-5/23_series/23228-550.zip). 3GPP is currently working towards the definition of the system requirements for messaging utilizing the SIP based IM CN subsystem. The plan is for messaging for the SIP based IM CN subsystem to be part of the 3GPP release 6 which is currently scheduled to be fully completed by June 2003.

The mechanism needed in an IM protocol are very similar to those needed to establish an interactive session, namely rapid delivery of small content to users at their current location, which can be dynamically changing as the users move. The similarity of needed functions imply that existing solutions for initiation of sessions, i.e. the Session Initiation Protocol SIP, is an ideal base for IM.

The Session Initiation Protocol (SIP) purpose is to create, modify, or terminate sessions with one or more participants. However, SIP is not intended as a general purpose transfer protocol in the way HTTP (Hypertext Transfer Protocol) or FTP is. One limitation of SIP in this regard is in the use of SIP over the UDP transport. On such a transport, the size of the SIP message is effectively bounded by the MTU to avoid fragmentation. There may be scenarios however where session related data needs to be conveyed and the given data exceeds the recommended size for a SIP message. There may also be scenarios where the session related data that needs to be conveyed does not directly reside on the endpoint or User Agent. In such scenarios, it is desirable to have a mechanism whereby the SIP message can contain an indirect reference to the desired content. The receiving party would then use this indirect reference to retrieve the content via a non-SIP transfer channel such as HTTP, FTP, or LDAP.

A User Agent (UA) is a software-based element which is capable of initiating requests and of responding to requests. It comprises two components, namely a User Agent Server (UAS) and a User Agent Client (UAC). The UAS receives requests and responds to them, while the UAC sends requests and receives responses to them.

When one user wishes to send an instant message to another, the sender formulates and issues a SIP request The request URI (Uniform Resource Identifier) of this request will normally be the URI of the party to whom the message is directed, and is usually a normal SIP URI. The body of the request will contain the message to be delivered. This body can be of any MIME type.

Provisional and final responses to the request will be returned to the sender as with any other SIP request. Normally, a 200 OK response will be generated by the user agent of the request's final recipient. Note that this indicates that the user agent accepted the message, not that the user has seen it.

FIG. 1 shows a schematic diagram of the basic technique of Instant Messaging with content indirection. Firstly, in step 10 the UA1 stores some content, e.g. a MIME body part or the entire payload, on a storage server 100 at a specific URI, which is returned to the UA1 in step 20. Then the UA1 sends an IM with an embedded link, i.e. said specific URI to a second UA2 via the IP Multimedia Subsystem IMS. Said second UA2 receives the IM and extracts the URI. In step 50 the UA2 requests the content referring to the URI from the storage server 100. Finally, in step 60 the requested content is returned to the UA2.

Since, the radio interface is a scarce resource the number and size of the messages exchanged over the radio interface between the UA and the network should be minimized. In particular the radio interface time spend to retrieve the requested content from the storage server to the UA2 is charged to the users access bill.

### SUMMARY OF THE INVENTION

It is an object of the invention to reduce the costs involved with retrieving content in a network system.

The object is solved by a method for authorising content download according to claim 1 as well as by a network system according to claim 8.

The invention is based on the idea to allow a User Agent UA to download the content via its associated proxy without being charged for the necessary radio interface time, i.e. the costs for downloading the content are be deducted from the users access charge.

According to the invention, a method for authorising content download in a network system is provided. Said method comprises the steps of receiving an message with an uniform resource identifier URI associated to a resource on a storage server 100; requesting said resource based on said uniform resource identifier URI from said storage server 100 via a resource proxy server 110, forwarding the content associated to said resource to said resource proxy server 110; authorising a download of said forwarded content from said resource proxy server 110 to a second User Agent UA2, performing an authorised download of said content, and subtracting the costs related to said authorised download of said content from overall costs.

The advantage of the above method is that the actual download of said content is free of charges, which will greatly enhance its attractivity for end users. Moreover, the cost of delivering a message can be set to the sender only—receiving a message would be free of charge.

According to a further embodiment of the invention, an accounting event is send to an accounting system within a network system, wherein said accounting event comprises a content indirection uniform resource identifier URI and wherein said accounting event is send, when said content indirection uniform resource identifier URI has passed the proxy server 110. Accounting records are generated of all downloads from said proxy server 110 to said second User Agent UA2, and the costs related to authorised downloads via the proxy server 110 are deduced from the overall costs.

Therefore no additional machinery is required for the charging of download costs. The charging can be performed by a post-processing function as long as appropriate accounting records can be generated by different nodes in a network system.

The object of the invention is also solved by a network system, comprising a storage server 100 for storing a resource at a specific Uniform Resource Identifier URI, at least a first and a second User Agent UA1, UA2 for transmitting and receiving messages IM between each other, wherein said message IM comprises an Uniform Resource Identifier URI associated to a resource stored on said storage server 100 Said network system further comprises a proxy server (110) for requesting a resource on said storage server 100 based on said Uniform Resource Identifier URI, for receiving the content associated to said resource from said storage server 100, for authorising a download of said received content, and for performing an authorised download of said content to said second User Agents (UA2). Finally, the costs related to said authorised download of said content are subtracted from the overall costs.

### BRIEF DESCRIPTION OF THE DRAWINGS

The invention will now be explained in more detail with reference to the drawing, in which:

FIG. 1 shows a schematic diagram of the basic technique of Instant Messaging with content indirection, and

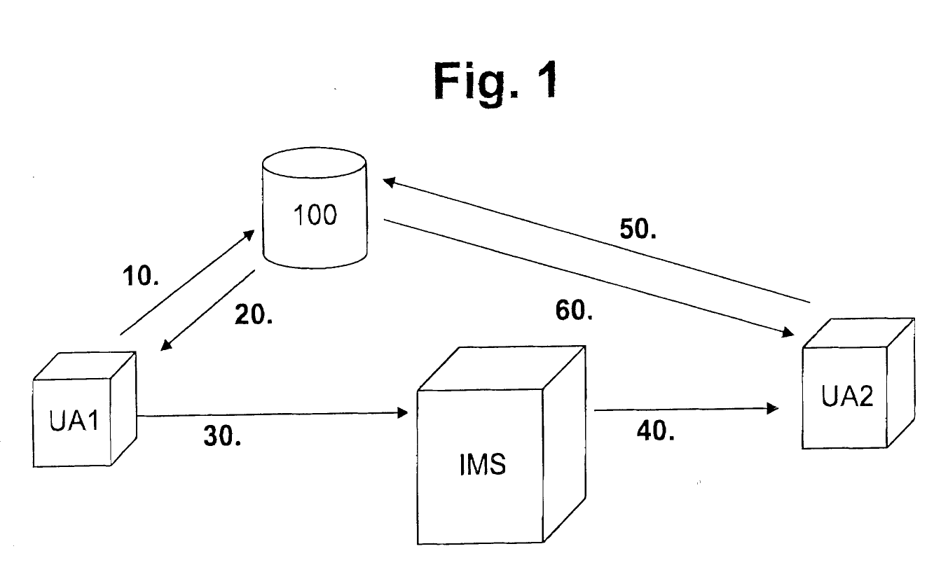

FIG. 2 shows a schematic diagram of Instant Messaging with content indirection according to a first embodiment.

### DESCRIPTION OF THE PREFERRED EMBODIMENT

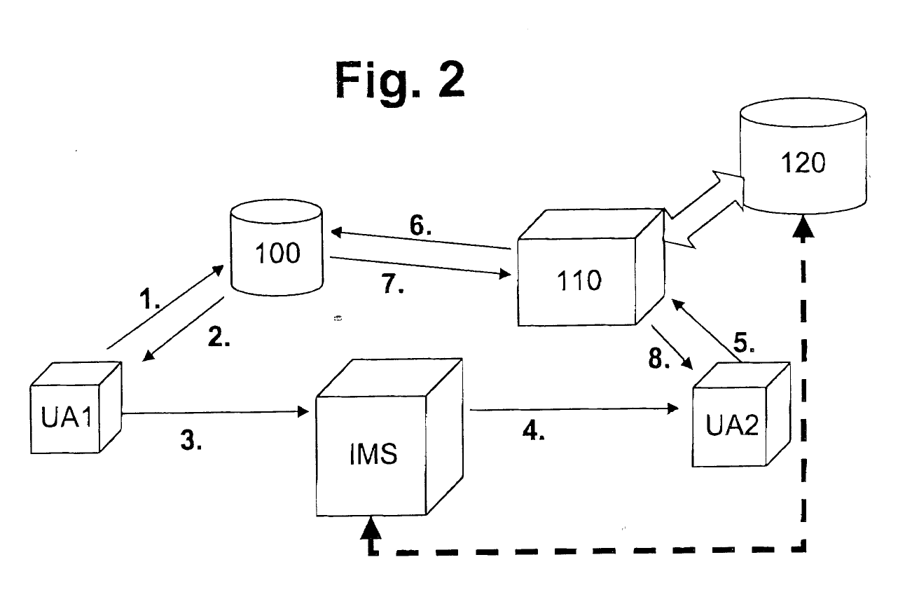

FIG. 2 shows a schematic diagram of Instant Messaging with content indirection according to a first embodiment of the invention. The network environment in question comprises a storage server 100, a first and second User Agent UA1, UA2, an IP Multimedia Subsystem IMS, and a known Proxy server 110 associated to said second UA2. In this environment said first UA1 sends an Instant Message IM and said second UA2 receives said IM.

Firstly, in step 1 said UA1 stores some content e.g. MIME type on a storage server 100 at a specific URI, which is returned to said UA1 in step 2. Said URI can e.g be of a HTTP URI type. Alternatively, said content can already be stored in said storage server 100, so that the UA1 merely has to add the respective URI of said indirect content. Then said UA1 sends an IM with an embedded link, i.e. said specific URI, to a second UA2 via the IP Multimedia Subsystem IMS (step 3). Said second UA2 receives the IM and extracts the URI of the indirect content and requests via its known Proxy 110 to download the content associated with said specific URI (step 5). The Proxy 110 then sends a requests to the storage server 100 for the content associated to said URI (step 6) and receives the requested content from said storage server (step 7). Having received the requested content the Proxy 110 forwards said content to the UA2 (step 8), i.e. the content is downloaded.

However, the basic idea of the invention is to allow the UA2 to download the indirect content via its associated proxy without being charged for the necessary radio interface time, i.e. the costs for downloading the content must be deducted from the users access charge. The aim is to authorize a download of indirect content in advance, i.e. before the actual download is started. This is achieved by using the IM messaging relay and the proxy server 110 associated to said receiving UA2.

The proxy server 110 can be a HTTP proxy server 110 and can be used as a resource proxy. The messaging relay is used to forward the IM to the users. The resource proxy is used to proxy resource download requests and responses to/from the user. The IM relay requests to open a resource at the resource HTTP proxy. Next, the resource proxy only allows those downloads of resources on the resource proxy which were specifically authorized by the IM relay beforehand.

Basically, accounting and charging correlation is used to reduce the access charges of the downloaded content.

Now the actual authorisation mechanism performed by the IM relay will be described in more detail. The IM relay or the SIP proxy may add an authorization token to the incoming message which is then used for authorization purposes when the content is downloaded. In other words, if an incoming message comprises such an authorization token, e.g. because said message contains indirect content, the resource proxy 110 can authorise a download. e.g. of said indirect content, free of charges. This token could be in the form of a resource proxy URL, the actual content URI included with encryption, or other authorization information.

Alternatively, if the IM relay detects indirect content in an IM, it can upload a state to the resource proxy 110 for that particular resource indicated by the indirect content. The condition of said state may be used to authorise the download of said indirect content free of charges. However, this requires that said state is maintained or stored in the resource proxy 110.

Regarding the actual charging for user access, e.g. a Gateway GPRS Support Node (GGSN) can perform the actual packet lookup and trace all traffic between the terminal equipment and the HTTP proxy IP address with the indirect content to be downloaded. The traffic due to the download of the indirect content is to be deducted from the GPRS access bill.

In particular, the IM relay can account the content indirection by sending an accounting event to an accounting system within the network system. Said accounting event lists the content indirection resource URI as having passed the relay (or SIP proxy). The known (HTTP) proxy 110 can then generate similar accounting records of all downloads from it. A charging system within the network system can then take care of the correlation. Preferably, said network system comprises a correlation means 120 for performing a correlation between said accounting events and said accounting records in a post-processing manner by deducing the accrued cost of all “authorized” downloads through the proxy 110 from the overall costs.

Furthermore, although the invention has been described in the first embodiment with reference to IM with indirect content, the basic principles to the invention may also be applied to other areas. E.g. the resource in question may also be a URL of a server which contains information which may be downloaded free of charge. In such a case, the authorisation of the download of said content may be performed by some generic entity.

The basic idea of the invention, namely to buy a right to access a particular content without being charged for the actual downloading, can also be used in other fields of mobile communication E.g. a user could buy an eBook (electronic book) for a fixed amount and read the chapters one by one downloading each chapters separately and subsequently without any additional access costs. Alternatively, this mechanism could be used for accessing operator announcements, updates or a web portal.

1. Method for authorising content download in a network system, comprising the steps of:
receiving a message with an uniform resource identifier (URI) associated to a resource on a storage server (100);
requesting said resource based on said uniform resource identifier (URI) from said storage server (100) via a resource proxy server (110), and forwarding the content associated to said resource to said resource proxy server (110);
authorising a download of said forwarded content from said resource proxy server (110) to a second User Agent (UA2);
performing an authorised download of said content; and
subtracting the costs related to said authorised download of said content from overall costs.

2. Method according to claim 1, comprising the step of:
receiving a message (IM) with indirect content from a first User Agent (UA1), wherein said message comprises an uniform resource identifier (URI) associated to said indirect content on a storage server (100);

3. Method according to claim 2.
wherein said message is an Instant Message (IM) with indirect content.

4. Method according to claim 3, further comprising the steps of:
sending an accounting event to an accounting system within a network system, wherein said accounting event comprises the content indirection uniform resource identifier (URI) and wherein said accounting event is send when said content indirection uniform resource identifier (URI) has passed the proxy server (110):
generating accounting records of downloads from said proxy server (110) to said second User Agent (UA2); and
deducing the costs related to authorised downloads via the proxy server (110) from the overall costs.

5. Method according to claim 3 or 4, comprising the steps of:
adding an authorization token to an incoming Instant Message (IM), when said Instant Message contains indirect content with said uniform resource identifier (URI); and
authorising a download of content being stored on said storage server (100) according to the presence of said token, wherein said content to be downloaded is associated to said uniform resource identifier (URI).

6. Method according to claim 5, wherein
said token is a resource proxy uniform resource location (URL), the actual content uniform resource identifier (URI) included with encryption, or authorization information.

7. Method according to claim 3 or 4, comprising the step of:
uploading a state to the proxy server (110) referring to said resource indicated by said indirect content on said storage server (100), when said Instant Message (IM) contains indirect content,
wherein said authorisation is performed according to said state.

8. Network system comprising:
a storage server (100) for storing a resource associated to a specific Uniform Resource Identifier (URI),
at least a first and a second User Agent (UA1, UA2) for transmitting and receiving messages (IM) between each other, wherein said message (IM) comprises an Uniform Resource Identifier (URI) associated to a resource stored on said storage server (100);
a proxy server (110) for requesting a resource on said storage server (100) based on said Uniform Resource Identifier (URI), for receiving the content associated to said resource from said storage server (100), for authorising a download of said received content, and for performing an authorised download of said content to said second User Agents (UA2); and
wherein the costs related to said authorised download of said content are subtracted from the overall costs.

9. Network system according to claim 8, wherein
said second user agent (UA2) is adopted to receive a message (IM) with indirect content from said first User Agent (UA1), wherein said message comprises an uniform resource identifier (URI) associated to said indirect content on a storage server (100).

10. Network system according to claim 9,
wherein said message is an Instant Message (IM) with indirect content.

11. Network system according to claim 10, further comprises:
means (120) for sending an accounting event to an accounting system within a network system, wherein said accounting event comprises the content indirection uniform resource identifier (URI) and wherein said accounting event is send when said content indirection uniform resource identifier (URI) has passed the proxy server (110); and
means (120) for generating accounting records of downloads from said proxy server (110) to said second User Agent (UA2);
wherein the costs related to authorised downloads via the proxy server (110) are deducted from the overall costs.

12. Network system according to claim 10 or 11, comprising
means (120) for adding an authorization token to an incoming Instant Message (IM), when said Instant Message contains indirect content with said uniform resource identifier (URI);
wherein a download of content being stored on said storage server (100) is authorised according to the presence of said token, wherein said content to be downloaded is associated to said uniform resource identifier (URI).

13. Network system according to claim 12, wherein
said token is a resource proxy uniform resource location (URL), the actual content uniform resource identifier (URI) included with encryption, or authorization information.

14. Network system according to claim 9 or 10, comprising:
wherein said proxy server (110) is adapted to upload a state referring to said resource indicated by said indirect content on said storage server (100), when said Instant Message (IM) contains indirect content,
wherein said authorisation is performed according to said state.
